(19) United States
(12) Patent Application Publication
(10) Pub. No.: US 2009/0322768 A1
(43) Pub. Date: Dec. 31, 2009

(54) Compile-time type-safe composable state objects

(76) Inventors: Paul A. Lalonde, Victoria (CA); Timothy J. Foley, Pleasant Hill, CA (US)

Correspondence Address: Caven & Aghevli LLC;c/o CPA Global, P.O. BOX 52050, MINNEAPOLIS, MN, 55402, US

(21) Appl. No.: 12/215,074

(22) Filed: Jun. 25, 2008

(51) Int. Cl. G06F 13/14

(52) U.S. Cl. 345/520

(57) ABSTRACT

Methods and apparatus to efficiently and safely interface with a graphics processing unit (GPU) are described. In one embodiment, procedures for transforming type-checked parameterized mappings into runtime mappings may be used to efficiently and safely (e.g., without introducing errors) interface with a GPU. Other embodiments are also described.

### FIELD

The present disclosure generally relates to the field of computing. More particularly, an embodiment of the invention generally relates to techniques for interfacing efficiently and safely with graphics processing units (GPUs).

### BACKGROUND

When designing software, a software developer may utilize a graphics processing unit (GPU) to display a visual output. In doing so, the developer may make incremental state changes in the GPU which may result in errors in the visual output, e.g., because the overall state of the GPU may be incoherent. These types of errors may be even more likely to occur in multithreaded environments where more than one thread of execution may call upon the graphics processing unit, for example, by requesting GPU state changes that are incremental or piecemeal. Moreover, if multiple threads were to update only a portion of the GPU state, race condition bugs may be introduced into the software and errors may be seen in the resulting display due to a mismatch of GPU state data.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates an embodiment of the parameterized state mappings, which may be utilized in accordance with some embodiments.

FIG. 2 illustrates a flow diagram of a method to interface with a GPU, according to some embodiments of the invention.

FIG. 3 illustrates a block diagram of the mapping algorithm, according to an embodiment.

FIG. 4 illustrates a block diagram representing the processing of an instruction that may be performed during the execution of a mapping algorithm, according to various embodiments of the invention.

FIGS. 5 and 6 illustrate block diagrams of embodiments of computing systems, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software (including for example micro-code that controls the operations of a processor), or some combination thereof.

Some of the embodiments discussed herein may allow a user (also referred to herein interchangeably as a “software developer” and/or “developer”) to efficiently and/or safely (e.g., without introducing errors such as inconsistent or invalid state) interface with graphics processing units. For example, a GPU may interface with multithreaded runtime executive programs where the executive programs send commands to update the state of the GPU from more than one thread. In one embodiment, the entire GPU state may be updated with each command, e.g., to provide coherency between various requested state changes (for example, originating from different threads).

Moreover, in some embodiments, input to the GPU may be type-checked and/or cross validated at compile time. For example, the parameterized mappings discussed further herein may be of a specific data type thereby resulting in compile-time type checking and more efficient processing of data. In some embodiments, runtime parameters and compositions may be range checked at submission time. In various embodiments, the engine provider (also referred to herein as a “software developer,” “developer,” and/or “user”) may specify mappings in terms of application-space data structures. For example, type-checking, cross validating, range checking, and making the GPU interface thread-safe may reduce possible graphics bugs introduced by a user. This may also make development easier, in part, because all the state is visible at one point instead of being scattered in program flow-control (as in DirectX® or OpenGL® for example).

Additionally, some of the embodiments discussed herein may allow for efficient submission of graphics objects that have a complex structure because these structures are interpreted and optimized at compile-time. Moreover, further optimizations may be made in a run-time executive, e.g., when a mapping is parameterized with another mapping for example.

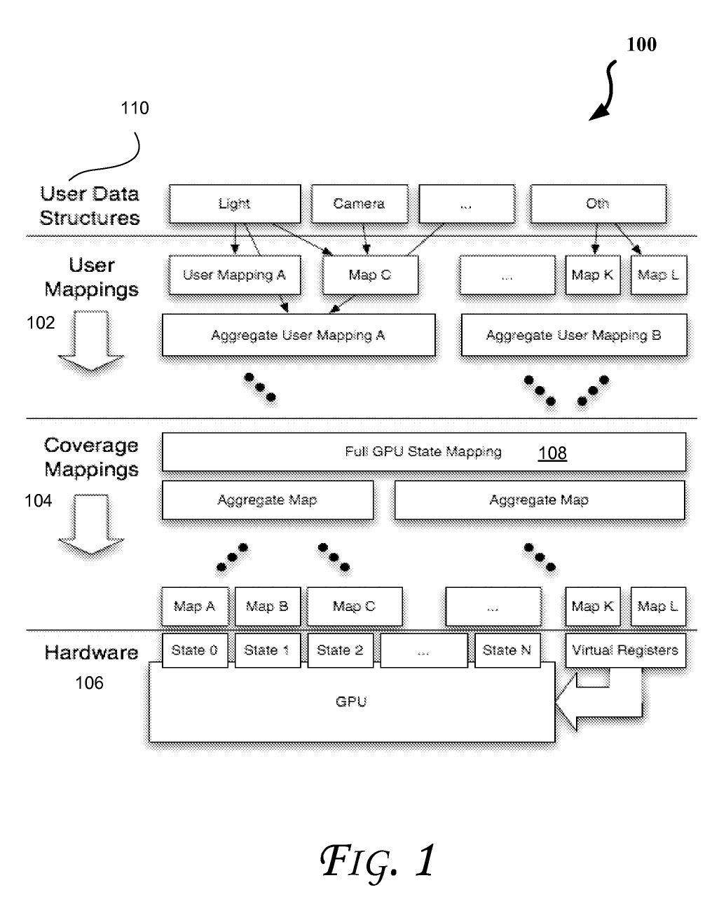

FIG. 1 illustrates an embodiment of the parameterized state mappings 100, which may be utilized in accordance with some embodiments. As shown, three kinds of state mappings may be developed, user mappings 102, coverage mappings 104, and/or hardware mappings 106. For example, the mappings may share the same specification language. In some embodiments, the state mappings may be parameterized using fully-typed variables (e.g., imported from the user's C code), and may include hierarchical structures and other mappings as parameters. In various embodiments, mappings may be composed to provide higher-level semantics than the hardware (e.g., GPU) does. Additionally, as discussed herein, the use of GPU may be interchangeable with a CPU in some embodiments.

In an embodiment, hardware state mappings 106 may describe every hardware (software in the case where the mappings are targeting DirectX®, OpenGL®, or some other software-based graphics processor interface) state that may be set, along with the corresponding data type. In some embodiments, the hardware state mappings 106 may describe every software state that may be set, along with the corresponding data type. For example, the hardware state mappings may map state data to a hardware implemented processor based GPU or to a software interface to a GPU (such as DirectX® or OpenGL®). Additionally, the hardware state mappings may include the low-level code to execute to set the state (either GPU command streams or DirectX/OpenGL function calls). Additionally, the encoding of the execution of hardware state mappings may be platform dependent in some embodiments.

In some embodiments, coverage state mappings 104 may aggregate hardware state mappings 106 to provide a user's view of the hardware interface. Additionally, an aggregate that includes the entire GPU state is called a GPU State Mapping 108, according to an embodiment. For example, coverage state mappings 104 may express constraints between the hardware states they aggregate. Additionally, coverage mappings 104 may be used to simulate unimplemented GPU features or to mask hardware bugs at a driver level. Moreover, submission of a GPU State Mapping may guarantee that the GPU will be set to a consistent state.

User state mappings 102 may allow a user to use data structures 110 as inputs to a GPU state mapping 108 (or to aggregate user mappings that eventually map onto a GPU state mapping), according to an embodiment. For example, this may provide compile-time guarantees that the data structures provide the data elements with the correct types. This may also allow the user to expose a “virtual GPU” in terms of his application data. For example, when the user wants to set the GPU state (e.g., to perform drawing operations for instance), he may submit a state mapping that implements all of the GPU State Mapping, for example, by submitting some aggregate of user mappings and their parameters. The runtime executive may execute the compiled mapping, e.g., looking up and remapping parameters from the data structures as specified in the parameters and setting the hardware state appropriately. In an embodiment, this process may be more efficient, in part, because all type-checking is done at compile-time.

In some embodiments, one or more software applications may be used to provide (e.g., through emulation) a virtual GPU. As GPUs evolve from hardware based devices to software based applications in accordance with some embodiments, e.g., making state changes increasingly less expensive to perform while remaining as expensive to specify, the interaction between the software engine (user application) and the GPU interface may be made more efficient, in accordance with some embodiments discussed herein.

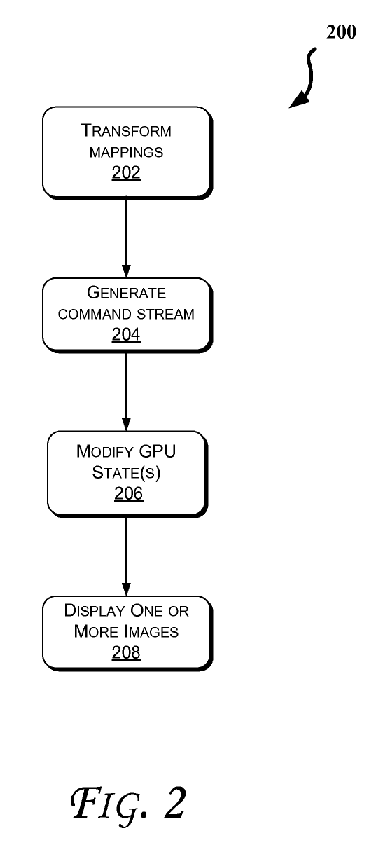

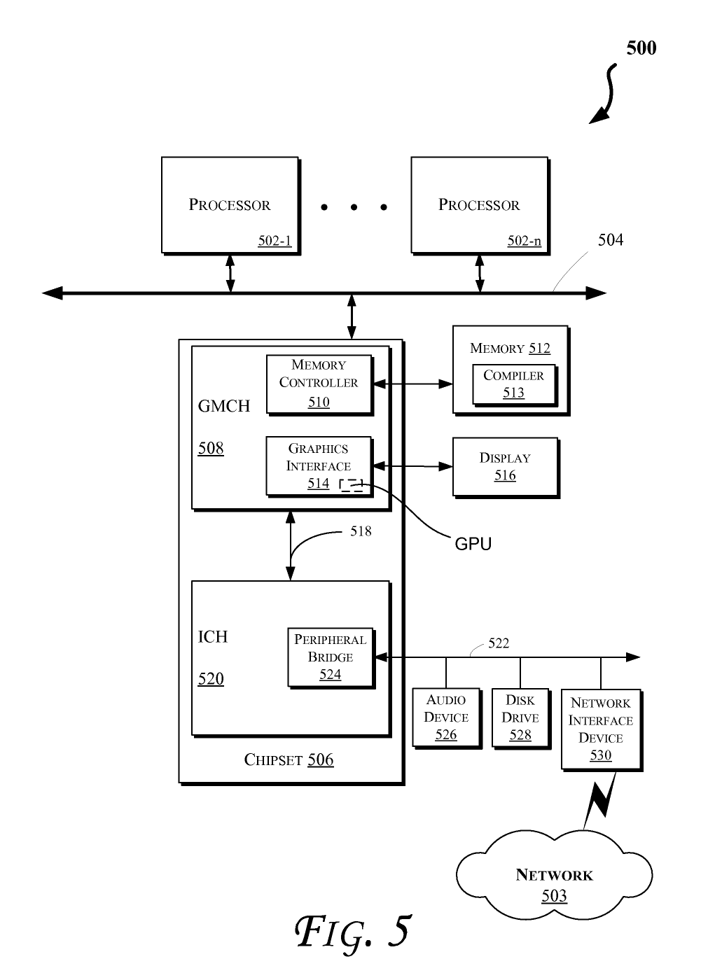

FIG. 2 illustrates a flow diagram of a method 200 to interface with a GPU, according to some embodiments of the invention. With reference to FIGS. 1, 3 and 4, at an operation 202, a compiler may transform parameterized state mappings into runtime state mappings, according to an embodiment. For example, the runtime state mappings may be in either an executable or byte code format and may be interpreted by the runtime executive when the user submits a state mapping and the parameters to execute it. At an operation 204, a runtime executive may generate command streams for a GPU in accordance with some embodiments. For example, the GPU interface may be implemented as hardware, software (such as DirectX or OpenGL), or combinations thereof. At an operation 206, one or more GPU states may be modified in accordance with the generated command stream of operation 204. In some embodiments, at operation 206, the runtime may support submission of GPU state changes from multiple threads of execution. At an operation 208, an image may be displayed on a display device (e.g., display device 516 of FIG. 5) based on the modification of the one or more GPU states. In am embodiment, operation 208 may instead, or additionally, read back the resulting image for non-visual interpretation by the CPU.

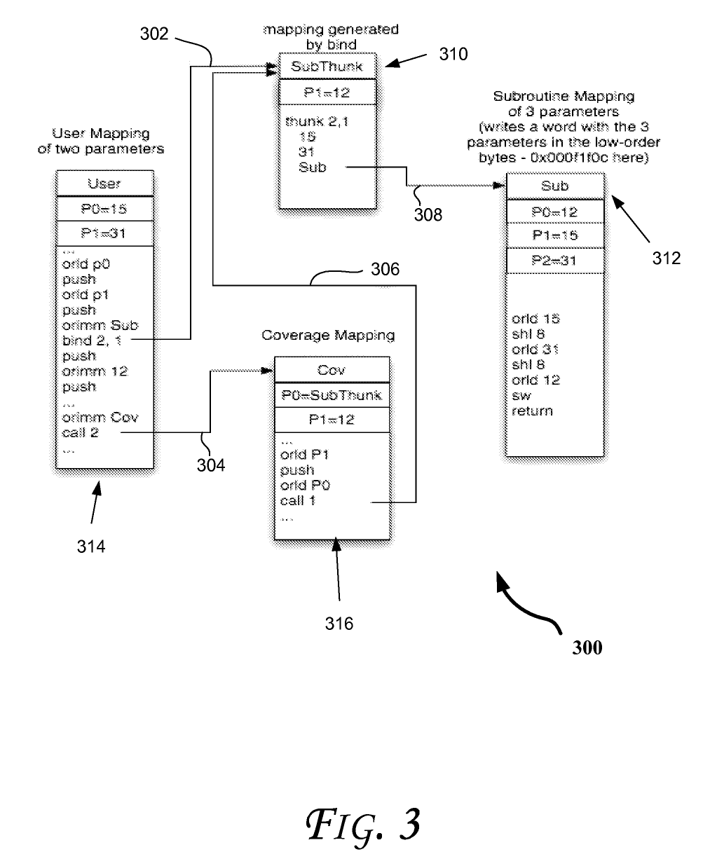

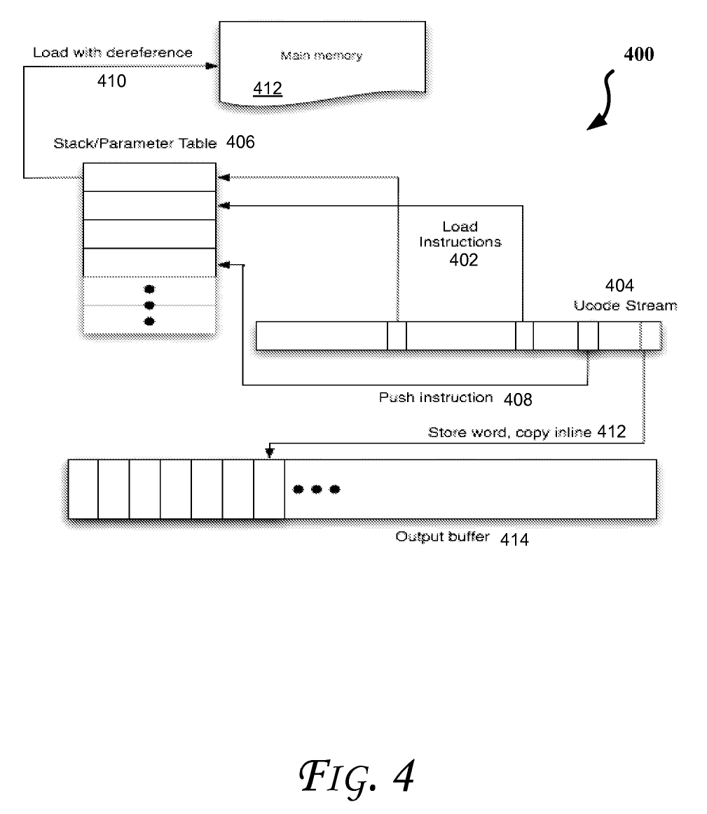

FIG. 3 illustrates a block diagram 300 of the mapping algorithm, according to an embodiment. Referring to the diagram 300, at 302, a bind operation may generate a thunk-stub 310 in the thunk-scratch space. For example, the thunk-stub 310 may be composed of two parameters from the stack (e.g., 15 and 31) and the target subroutine address (e.g., Sub 312). Additionally, the return value of the bind may be the address of this new code (e.g., SubThunk 310). At 304, the user's mapping 314 may call the mapping it is specializing 316 (e.g., Cov), according to an embodiment. For example, Cov 316 may be parameterized by a mapping of one parameter (e.g., parameter one—P0—may map to SubThunk instead of an integer), and a second integer parameter. According to some embodiments, at 306, Cov 316 may set up the stack as if it was calling a one-parameter function, and may look up the address of the function to call from its parameter list, thereby invoking the thunk-stub 310 SubThunk. As discussed further herein with reference to FIG. 4 below, at 308, SubThunk's 310 thunk instruction may push its call parameter onto a stack, push the thunk's 2 parameters onto the stack, and then may invoke Sub, passing it its three parameters. Finally, Sub 304 may return to the instruction following the call in Cov 316.

FIG. 4 illustrates a block diagram 400 representing the processing of a sequence of instruction that may be performed during the execution of a mapping algorithm, according to various embodiments of the invention. In some embodiments, instructions may be decoded into one or more micro-operations (also referred to as a “uop”). Accordingly, as discussed herein, use of “instruction” may be interchangeable with “uop.”

Referring to FIG. 4, at an operation 402, an instruction such as Ucode Stream 404 may push its call parameter onto a stack 406 (e.g., SubThunk's thunk instruction from FIG. 3). In some embodiments, the Ucode Stream 404 may be single instruction or multiple instructions. For example, operation 402, 406, 408, and 412 may be performed in accordance with separate instructions. At 408, the instruction 404 may push the instruction's parameters (e.g., in this case two parameters) onto the stack 406. At 410, the instruction 404 may invoke a subroutine (e.g., Sub from FIG. 3) by loading it into memory 412 and passing the instruction's parameters (e.g., the call parameter and the thunk's two parameters) to the subroutine. At an operation 412, the subroutine may return its result to the instruction by copying the result into an output buffer 414.

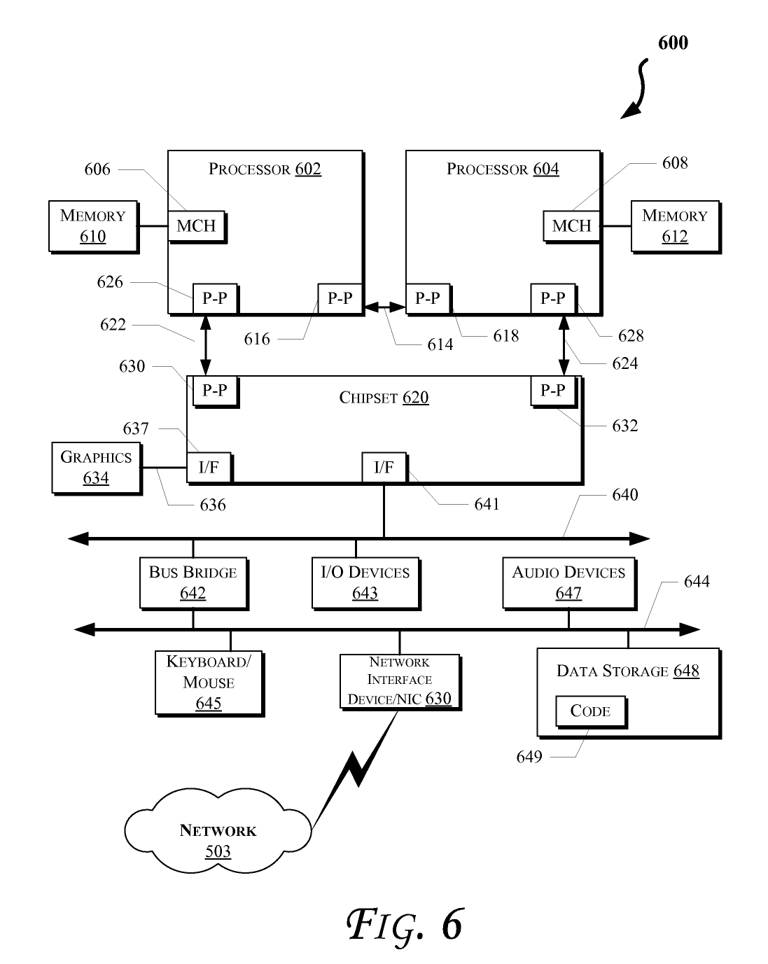

FIG. 5 illustrates a block diagram of an embodiment of a computing system 500. In various embodiments, one or more of the components of the system 500 may be provided in various electronic devices capable of performing one or more of the operations discussed herein with reference to some embodiments of the invention. For example, one or more of the components of the system 500 may be used to perform the operations discussed with reference to FIGS. 1-4, e.g., by processing mapping instructions, executing subroutines, etc. in accordance with the operations discussed herein. Also, various storage devices discussed herein (e.g., with reference to FIGS. 5 and/or 6) may be used to store data, operation results, etc. In one embodiment, data received over the network 503 (e.g., via network interface devices 530 and/or 630) may be stored in caches (e.g., L1 caches in an embodiment) present in processors 502 (and/or 602 of FIG. 6). These processor(s) may then apply the operations discussed herein to interface with a GPU in accordance with various embodiments of the invention.

More particularly, the computing system 500 may include one or more central processing unit(s) (CPUs) 502 or processors that communicate via an interconnection network (or bus) 504. Hence, various operations discussed herein may be performed by a CPU in some embodiments. Additionally, as discussed herein, the use of GPU may be interchangeable with a CPU in some embodiments. For example, the processors 502 may include logic to support graphics functions. Moreover, the processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. Moreover, the operations discussed with reference to FIGS. 1-4 may be performed by one or more components of the system 500.

A chipset 506 may also communicate with the interconnection network 504. The chipset 506 may include a graphics and memory control hub (GMCH) 508. The GMCH 508 may include a memory controller 510 that communicates with a memory 512. The memory 512 may store data, including sequences of instructions that are executed by the CPU 502, or any other device included in the computing system 500 such as a GPU. In an embodiment, the memory 512 may be the same or similar to the main memory 412 of FIG. 4. Furthermore, memory 512 may store one or more of the programs or algorithms discussed herein such as a compiler 513, instructions corresponding to executables, mappings, etc. Same or at least a portion of this data (including instructions may be stored in disk drive 528 and/or one or more caches within processors 502. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The GMCH 508 may also include a graphics interface 514 that communicates with a display 516. In one embodiment of the invention, the graphics interface 514 may communicate with the display 516 via an accelerated graphics port (AGP) or a GPU. For example, one or more GPUs may be incorporated into the display 516 and/or graphics interface 514, or elsewhere in system 500 (e.g., within a device or card coupled to the bus 522 such as a graphics card, in the GMCH 508 or ICH 520, etc.). Alternatively, one or more of processors 502 may be used as a GPU. In an embodiment of the invention, the display 516 may be a flat panel display that communicates with the graphics interface 514 through, for example, a signal converter that translates a digital representation of an image stored in a storage device such as video memory or system memory into display signals that are interpreted and displayed by the display 516. The display signals produced by the interface 514 may pass through various control devices before being interpreted by and subsequently displayed on the display 516.

A hub interface 518 may allow the GMCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530, which may be in communication with the computer network 503. In an embodiment, the device 530 may be a NIC capable of wireless communication. Other devices may communicate via the bus 522. Also, various components (such as the network interface device 530) may communicate with the GMCH 508 in some embodiments of the invention. In addition, the processor 502, the GMCH 508, and/or the graphics interface 514 may be combined to form a single chip.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration such as discussed with reference to FIG. 5. For example, processors, memory, and/or input/output devices may be interconnected by a number of point-to-point interfaces.

More specifically, FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 (which may be the same or similar to the GMCH 508 of FIG. 5 in some embodiments) to couple with memories 610 and 612. The memories 610 and/or 612 may store various data such as those discussed with reference to the memory 512 of FIG. 5.

The processors 602 and 604 may be any suitable processor such as those discussed with reference to the processors 602 of FIG. 6. The processors 602 and 604 may exchange data via a point-to-point (PtP) interface 614 using PtP interface circuits 616 and 618, respectively. The processors 602 and 604 may each exchange data with a chipset 620 via individual PtP interfaces 622 and 624 using point to point interface circuits 626, 628, 630, and 632. The chipset 620 may also exchange data with a high-performance graphics circuit 634 via a high-performance graphics interface 636, using a PtP interface circuit 637.

At least one embodiment of the invention may be provided by utilizing the processors 602 and 604. For example, the processors 602 and/or 604 may perform one or more of the operations of FIGS. 1-5 (e.g., discussed with reference to GPUs). Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may be coupled to a bus 640 using a PtP interface circuit 641. The bus 640 may have one or more devices coupled to it, such as a bus bridge 642 and I/O devices 643. Via a bus 644, the bus bridge 643 may be coupled to other devices such as a keyboard/mouse 645, the network interface device 630 discussed with reference to FIG. 6 (such as modems, network interface cards (NICs), or the like that may be coupled to the computer network 503), audio I/O device, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., logic circuitry), software (including, for example, micro-code that controls the operations of a processor such as the processors discussed with reference to FIGS. 5-6), firmware, or combinations thereof, which may be provided as a computer program product, e.g., including a tangible machine-readable or computer-readable medium having stored thereon instructions (or software procedures) used to program a computer (e.g., a processor or other logic of a computing device) to perform an operation discussed herein. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, e.g., through a carrier wave or other propagation medium, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. A method comprising:
transforming one or more parameterized state mappings into one or more corresponding runtime state mappings;
generating a command stream for a graphics processing unit (GPU) based upon the one or more runtime state mappings and one or more parameters;
modifying one or more GPU states based upon the command stream corresponding to a first thread;
modifying the one or more GPU states based upon the command stream corresponding to a second thread; and
displaying an image on a display device based on the modification of the one or more GPU states.

2. The method of claim 1, wherein each of the one or more parameterized state mappings is one of a hardware state mapping, a coverage state mapping, a GPU state mapping, or a user state mapping.

3. The method of claim 1, wherein each of the one or more parameterized state mappings is parameterized using fully-typed variables.

4. The method of claim 1, further comprising composing the parameterized state mappings to provide high-level semantics.

5. The method of claim 1, further comprising generating one or more hardware state mappings corresponding to each of the one or more GPU states, wherein each of the one or more hardware state mappings comprises a data type.

6. The method of claim 5, further comprising generating a GPU state mapping comprising each of the one or more hardware state mappings.

7. The method of claim 5, further comprising generating a user state mapping by mapping one or more user data structures to each of the one or more hardware state mappings that comprise the GPU state mapping.

8. The method of claim 1, further comprising generating one or more coverage state mappings comprising one or more hardware state mappings to provide one or more views of a GPU interface.

9. The method of claim 1, further comprising modifying each of the one or more GPU states based on a single command.

10. A computer-readable medium comprising one or more instructions that when executed on a processor configure the processor to perform one or more operations to:
transform one or more parameterized state mappings into one or more corresponding runtime state mappings;
generate a command stream for a graphics processing unit (GPU) based upon the one or more runtime state mappings and one or more parameters;
modify one or more GPU states based upon the command stream corresponding to a first thread; and
modify the one or more GPU states based upon the command stream corresponding to a second thread.

11. The computer-readable medium of claim 10, wherein each of the one or more parameterized state mappings is one of a hardware state mapping, a coverage state mapping, a GPU state mapping, or a user state mapping.

12. The computer-readable medium of claim 10, wherein each of the one or more parameterized state mappings is parameterized using fully-typed variables.

13. The computer-readable medium of claim 10, further comprising one or more instructions that when executed on a processor configure the processor to perform one or more operations to generate one or more hardware state mappings corresponding to each of the one or more GPU states, wherein each of the one or more hardware state mappings comprises a data type.

14. The computer-readable medium of claim 13, further comprising one or more instructions that when executed on a processor configure the processor to perform one or more operations to generate one or more coverage state mappings comprising one or more hardware state mappings to provide one or more views of a GPU interface.

15. The computer-readable medium of claim 13, further comprising one or more instructions that when executed on a processor configure the processor to perform one or more operations to generate a GPU state mapping comprising each of the one or more hardware state mappings.

16. The computer-readable medium of claim 15, further comprising one or more instructions that when executed on a processor configure the processor to perform one or more operations to generate a user state mapping by mapping one or more user data structures to each of the one or more hardware state mappings that comprise the GPU state mapping.

17. The computer-readable medium of claim 10, further comprising one or more instructions that when executed on a processor configure the processor to perform one or more operations to modify each of the one or more GPU states based on a single command.

18. A system comprising:
a memory to store a GPU state mapping instruction; and
a processor to execute the GPU state mapping instruction to modify one or more GPU states based on information from a plurality of threads.

19. The system of claim 18, wherein the processor is to perform a plurality of operations comprising:
transforming one or more parameterized state mappings into one or more corresponding runtime state mappings;
generating a command stream for a graphics processing unit (GPU) based upon the one or more runtime state mappings and one or more parameters;
modifying one or more GPU states based upon the command stream corresponding to a first thread; and
modifying the one or more GPU states based upon the command stream corresponding to a second thread.

20. The system of claim 19, wherein each of the one or more parameterized state mappings is one of a hardware state mapping, a coverage state mapping, a GPU state mapping, or a user state mapping.
